(19) United States
(12) Patent Application Publication
(10) Pub. No.: US 2020/0143774 A1
(43) Pub. Date: May 7, 2020

(54) INFORMATION PROCESSING DEVICE, INFORMATION PROCESSING METHOD, AND COMPUTER PROGRAM

(71) Applicant: SONY CORPORATION, TOKYO (JP)

(72) Inventors: SHUNITSU KOHARA, TOKYO (JP); RYO FUKAZAWA, KANAGAWA (JP); KEI NITTA, TOKYO (JP); KOICHI KAWASAKI, TOKYO (JP); HIROTAKE ICHIKAWA, TOKYO (JP)

(21) Appl. No.: 16/631,884

(22) PCT Filed: May 2, 2018
(86) PCT No.: PCT/JP2018/017505

§ 371 Date: Jan. 17, 2020

(30) Foreign Application Priority Data
Jul. 26, 2017 (JP) 2017-144310

(51) Int. Cl. G09G 5/37; G06F 3/0484; G09G 5/38; G06K 9/00

(52) U.S. Cl. CPC G09G 5/37; G06F 3/04842; G09G 2354/00; G06K 9/00671; G09G 5/38

(57) ABSTRACT

[Problem] To provide an information processing device, an information processing method, and a computer program.

[Solution] To provide an information processing device including a display control unit that controls display so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.

### FIELD

The present disclosure relates to an information processing device, an information processing method, and a computer program.

### BACKGROUND

In recent years, a technique of superimposing a virtual object on a real space to be presented to a user, which is called Augmented Reality (AR), has been attracting attention. For example, by using a projector or a Head Mounted Display (hereinafter, also referred to as an “HMD”) including a display that is positioned in front of the eyes of the user when being worn on a head part of the user, a virtual object is enabled to be displayed while being superimposed on a real space.

In such an AR technique, the virtual object is displayed based on information of a real object present in the real space. For example, a virtual object corresponding to the information of the real object that is recognized based on an image taken by a camera is displayed to be superimposed on the recognized real object. The following Patent Literature 1 discloses a technique of determining a display region of a virtual object to be displayed on a display surface in accordance with information of a real object present on the display surface.

### CITATION LIST

### Patent Literature

Patent Literature 1: WO 2014/171200

### SUMMARY

### Technical Problem

In a case of displaying the virtual object based on the information of the real object as described above, a virtual object desirable for a user is not necessarily displayed.

Thus, the present disclosure provides new and improved information processing device, information processing method, and computer program that enable a virtual object more desirable for a user to be displayed by controlling display based on a selection made by the user.

### Solution to Problem

According to the present disclosure, an information processing device is provided that includes: a display control unit configured to control display so that, of a first real object and a second real object that are present in a real space and recognized as candidates for an object to be operated, in a case in which the first real object is selected by a user as the object to be operated, a first virtual object corresponding to the first real object is caused to be displayed at a first position in the real space corresponding to a position of the first real object based on the selection made by the user, and in a case in which the second real object is selected by the user as the object to be operated, a second virtual object corresponding to the second real object is caused to be displayed at a second position in the real space corresponding to a position of the second real object based on the selection made by the user.

Moreover, according to the present disclosure, an information processing method is provided that includes: controlling display by a processor so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.

Moreover, according to the present disclosure, a computer program is provided that causes a computer to implement a function of controlling display so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.

### Advantageous Effects of Invention

As described above, according to the present disclosure, a virtual object more desirable for a user is enabled to be displayed by controlling display based on a selection made by the user.

The effects described above are not limitations, and any of the effects disclosed herein or another effect that may be grasped from the present description may be exhibited in addition to the effects described above, or in place of the effects described above.

### BRIEF DESCRIPTION OF DRAWINGS

FIG. 1 is a diagram for explaining an outline of an information processing device 1 according to an embodiment of the present disclosure.

FIG. 2 is a block diagram illustrating a configuration example of the information processing device 1 according to the embodiment.

FIG. 3 is a flowchart illustrating a processing procedure performed by the information processing device 1 according to the embodiment.

FIG. 4 is an explanatory diagram for explaining an example of a specific operation of the information processing device 1 according to the embodiment.

FIG. 5 is an explanatory diagram illustrating a hardware configuration example.

### DESCRIPTION OF EMBODIMENTS

### Description of Embodiments

The following describes a preferred embodiment of the present disclosure in detail with reference to the attached drawings. In the present description and the drawings, constituent elements having substantially the same functional configuration are denoted by the same reference numeral, and redundant description will not be repeated.

In the present description and drawings, a plurality of constituent elements having substantially the same functional configuration are distinguished from each other by adding different alphabets to the same reference numeral in some cases. However, in a case in which the constituent elements having substantially the same functional configuration are not required to be distinguished from each other, only the same reference numeral is given thereto.

The description will be made in the following order.

1. Outline

2. Configuration

3. Operation
3-1. Processing procedure
3-2. Specific example

4. Modification
4-1. First modification
4-2. Second modification
4-3. Third modification

5. Hardware configuration example

6. Conclusion

### 1. OUTLINE

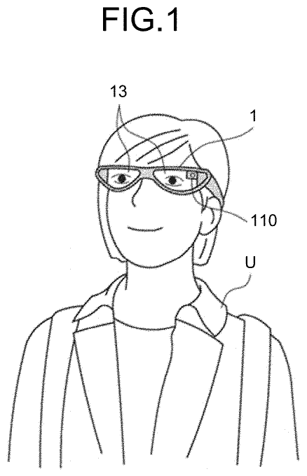

First, the following describes an outline of an information processing device according to an embodiment of the present disclosure. FIG. 1 is a diagram for explaining an outline of an information processing device 1 according to the embodiment. As illustrated in FIG. 1, the information processing device 1 according to the embodiment is implemented by a spectacle-type Head Mounted Display (HMD) worn on a head part of a user U, for example. Display units 13 corresponding to spectacle lens portions that are positioned in front of the eyes of the user U when being worn may be a transmissive type or a non-transmissive type. The information processing device 1 can present a virtual object ahead of a line of sight of the user U by displaying the virtual object on the display units 13. The HMD as an example of the information processing device 1 does not necessarily present an image to both eyes, and may present the image to only one eye. For example, the HMD may be a monocular type including the display unit 13 that presents an image to one eye disposed therein.

The information processing device 1 includes an outward camera 110 disposed therein that images a direction of the line of sight of the user U, that is, an outward direction when being worn. Additionally, although not illustrated in FIG. 1, the information processing device 1 also includes various sensors disposed therein such as an inward camera that images the eye of the user U when being worn and a microphone (hereinafter, referred to as a “mic”). A plurality of outward cameras 110 and inward cameras may be disposed. In a case in which a plurality of outward cameras 110 are disposed, a depth image (distance image) can be obtained based on parallax information, and a surrounding environment can be three-dimensionally sensed. Even in a case in which one outward camera 110 is used, depth information (distance information) can be estimated based on a plurality of images.

The shape of the information processing device 1 is not limited to the example illustrated in FIG. 1. For example, the information processing device 1 may be a headband-type (a type of being worn with a band wound around the entire circumference of the head part. In some cases, there may be disposed a band passing through not only a temporal region but also a head top part) HMD, or a helmet-type (a visor portion of the helmet corresponds to the display) HMD. The information processing device 1 may also be implemented by a wearable device of a wristband type (for example, a smart watch including a display or no display), a headphone type (without a display), a neckphone type (a neck-hanging type including a display or no display), or the like.

An operation input for a wearable device that may be worn by the user like the information processing device 1 according to the embodiment may be performed based on a movement and voice of the user sensed by a sensor such as the camera described above, for example. For example, it can be considered to receive an operation input using a virtual object such as a gesture of touching the virtual object displayed on the display unit 13. However, the virtual object is unreal, so that it has been difficult for the user to intuitively make such an operation input using the virtual object as compared with an operation input performed by using a real controller, for example.

Thus, the information processing device 1 according to the embodiment receives an operation input using a real object present in the real space. For example, the information processing device 1 according to the embodiment may receive, as the operation input, movement of the real object, rotation of the real object, or touching of the real object performed by the user. With this configuration, an operation input more intuitive for the user than the operation input using the virtual object may be implemented. In the following description, the real object used for the operation input in the embodiment may be referred to as an object to be operated in some cases.

In the embodiment, the object to be operated is not limited to a dedicated controller prepared in advance or a specific real object determined in advance, and may be various real objects present in the real space. For example, the object to be operated according to the embodiment may be any real object such as a writing tool, a can, a book, a clock, and an eating utensil present around the periphery. With this configuration, convenience for the user is improved.

As described above, the object to be operated is not limited to a dedicated controller prepared in advance or a specific real object determined in advance, so that it is desirable to notify the user of whether which of real objects present around the periphery is the object to be operated. Thus, the information processing device 1 according to the embodiment may display the virtual object indicating that the real object is the object to be operated that can receive the operation input from the user (an example of information about the operation input using the object to be operated). The virtual object is displayed at a position corresponding to the position of the object to be operated, for example, may be displayed to be superimposed on the object to be operated or displayed in the vicinity of the object to be operated.

In this case, among the real objects present around the periphery, a real object that does not meet user's preference (for example, the operation input is difficult to be performed) may be assigned as the object to be operated when the real object is automatically assigned as the object to be operated. If all real objects that are present around the periphery and can be utilized as the object to be operated are assumed to be objects to be operated, and virtual objects corresponding to the objects to be operated are displayed, a virtual object not desirable for the user is displayed in some cases. Specifically, if a virtual object corresponding to a real object other than the object to be operated that is actually used for the operation input by the user is kept being displayed, the operation input performed by the user may be obstructed.

Thus, the information processing device 1 according to the embodiment performs assignment of the object to be operated and display of the virtual object based on the selection made by the user to implement assignment of the object to be operated more preferred by the user and display of the virtual object desired by the user. Specifically, the information processing device 1 specifies the object to be operated from among the real objects that are present in the real space and recognized as candidates for the object to be operated based on the selection made by the user, and causes the virtual object corresponding to the specified object to be operated to be displayed.

### 2. CONFIGURATION

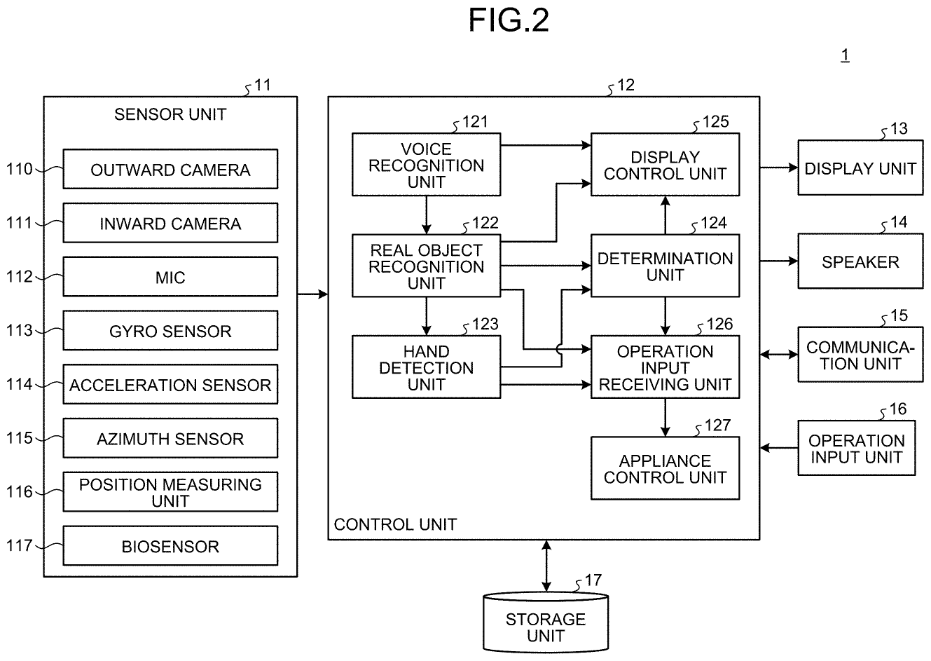

The outline of the information processing device 1 according to the embodiment has been described above. Subsequently, the following describes a configuration of the information processing device 1 according to the embodiment with reference to FIG. 2. FIG. 2 is a block diagram illustrating a configuration example of the information processing device 1 according to the embodiment. As illustrated in FIG. 2, the information processing device 1 includes a sensor unit 11, a control unit 12, a display unit 13, a speaker 14, a communication unit 15, an operation input unit 16, and a storage unit 17.

Sensor Unit 11

The sensor unit 11 has a function of acquiring various kinds of information about the user or a peripheral environment. For example, the sensor unit 11 includes the outward camera 110, an inward camera 111, a mic 112, a gyro sensor 113, an acceleration sensor 114, an azimuth sensor 115, a position measuring unit 116, and a biosensor 117. A specific example of the sensor unit 11 described herein is merely an example, and the embodiment is not limited thereto. Additionally, a plurality of sensors may be disposed.

Each of the outward camera 110 and the inward camera 111 includes a lens system constituted of an imaging lens, a diaphragm, a zoom lens, a focus lens, and the like, a driving system that causes the lens system to perform a focus operation or a zoom operation, a solid-state imaging element array that photoelectrically converts imaging light obtained by the lens system to generate an imaging signal, and the like. The solid-state imaging element array may be implemented by a Charge Coupled Device (CCD) sensor array, or a Complementary Metal Oxide Semiconductor (CMOS) sensor array, for example.

The mic 112 collects voice of the user and environmental sound of the surroundings to be output to the control unit 12 as voice data.

The gyro sensor 113 is implemented by a triaxial gyro sensor, for example, and detects an angular speed (rotational speed).

The acceleration sensor 114 is implemented by a triaxial acceleration sensor (also referred to as a G sensor), for example, and detects acceleration at the time of movement.

The azimuth sensor 115 is implemented by a triaxial geomagnetic sensor (compass), for example, and detects an absolute direction (azimuth).

The position measuring unit 116 has a function of detecting a present position of the information processing device 1 based on a signal acquired from the outside. Specifically, the position measuring unit 116 is implemented by a Global Positioning System (GPS) measuring unit, for example, receives radio waves from GPS satellites, detects a position at which the information processing device 1 is present, and outputs detected positional information to the control unit 12. Alternatively, the position measuring unit 116 may detect the position, for example, via Wi-Fi (registered trademark), Bluetooth (registered trademark), transmission/reception of data to/from a cellular telephone, a PHS, a smartphone, and the like, short-range communication, or the like in place of the GPS.

The biosensor 117 detects biological information of the user. Specifically, for example, the biosensor 117 may detect heartbeats, a body temperature, sweating, a blood pressure, a pulse, respiration, nictitation, an eye movement, a gazing time, a size of pupil diameter, a blood pressure, brain waves, body motion, a posture, a skin temperature, electric skin resistance, micro vibration (MV), a myoelectric potential, blood oxygen saturation (SPO2), or the like.

Control Unit 12

The control unit 12 functions as an arithmetic processing device and a control device, and controls the entire operation in the information processing device 1 in accordance with various computer programs. As illustrated in FIG. 2, the control unit 12 according to the embodiment functions as a voice recognition unit 121, a real object recognition unit 122, a hand detection unit 123, a determination unit 124, a display control unit 125, an operation input receiving unit 126, and an appliance control unit 127.

The voice recognition unit 121 recognizes the user or environmental sound by using various kinds of sensor information sensed by the sensor unit 11. For example, the voice recognition unit 121 may perform noise removal, sound source separation, and the like on collected sound information acquired with the mic 112, and perform voice recognition, morphological analysis, sound source recognition, noise level recognition, or the like. The voice recognition unit 121 may detect a predetermined voice command as a trigger for starting the operation input. The predetermined voice command may be prepared in advance in accordance with a function corresponding to the operation input, and the predetermined voice command for starting the operation input corresponding to a function of changing output sound volume of the speaker 14 may be “Change TV volume”, for example.

The real object recognition unit 122 recognizes information about the real object present in the real space by using various kinds of sensor information sensed by the sensor unit 11. The real object recognition unit 122 analyzes, for example, a taken image acquired by the outward camera 110 or a depth image that is acquired based on a plurality of taken images, and recognizes information about the real object such as a shape, a design, a size, classification, an angle, a three-dimensional position in the real space, and the like of the real object. For example, in a case in which the predetermined voice command is detected by the voice recognition unit 121 as a trigger for starting the operation input, the real object recognition unit 122 may start processing related to the recognition described above.

The real object recognition unit 122 recognizes the candidate for the object to be operated based on the information about the recognized real object. The real object recognition unit 122 may recognize all of the recognized real objects as the candidates for the object to be operated, or may recognize a real object meeting a condition determined in advance among the recognized real objects as the candidate for the object to be operated. The condition determined in advance may be, for example, having a predetermined shape, having a predetermined design, having a size equal to or smaller than a predetermined size, having a size equal to or larger than a predetermined size, being a real object of predetermined classification, being present in a predetermined range, and the like. The following exemplifies a case in which the real object recognition unit 122 recognizes at least two real objects as the candidates for the object to be operated, and the two real objects are distinguished from each other by being referred to as a first real object and a second real object. However, the number of candidates for the object to be operated that may be recognized by the real object recognition unit 122 is not limited to 2, and may be equal to or larger than 3.

The hand detection unit 123 detects a user's hand by using various kinds of sensor information sensed by the sensor unit 11. The hand detection unit 123 detects the user's hand by analyzing a taken image acquired by the outward camera 110 or a depth image that is acquired based on a plurality of taken images, for example. Alternatively, the hand detection unit 123 may detect a three-dimensional position of the hand in the real space.

The determination unit 124 performs determination related to the selection of the object to be operated made by the user. For example, among the real objects that are recognized as the candidates for the object to be operated by the real object recognition unit 122, the determination unit 124 may determine a real object touched by the user to be a real object selected by the user as the object to be operated. That is, the determination unit 124 may determine that the first real object is selected as the object to be operated in a case in which the user touches the first real object, and may determine that the second real object is selected as the object to be operated in a case in which the user touches the second real object.

Among the real objects recognized as the candidates for the object to be operated by the real object recognition unit 122, the determination unit 124 may determine a real object firstly touched by the user to be the real object selected by the user as the object to be operated. That is, even if the user touches the second real object after the determination unit 124 determines that the first real object is selected as the object to be operated based on the fact that the user touches the first real object, the determination unit 124 does not necessarily determine that the second real object is selected as the object to be operated. Similarly, even if the user touches the first real object after the determination unit 124 determines that the second real object is selected as the object to be operated based on the fact that the user touches the second real object, the determination unit 124 does not necessarily determine that the first real object is selected as the object to be operated.

Alternatively, the determination unit 124 may determine whether the user touches the real object based on the three-dimensional position of the hand detected by the hand detection unit 123 and the three-dimensional position of the real object that is recognized as the candidate for the object to be operated by the real object recognition unit 122.

The display control unit 125 controls display performed by the display unit 13. As described above with reference to FIG. 1, the display unit 13 is present in front of the eye of the user, so that the virtual object displayed on the display unit 13 is visually recognized as if being present in the real space by the user in a case in which the display unit 13 is a transmissive type. By controlling display of the virtual object performed by the display unit 13, the display control unit 125 can control the position of the virtual object in the real space (position that is visually recognized as if the virtual object is present by the user).

The display control unit 125 according to the embodiment controls display so that the virtual object corresponding to the real object is displayed at a position in the real space corresponding to the real object selected as the object to be operated based on the selection made by the user that is determined by the determination unit 124.

For example, in a case in which the first real object is selected as the object to be operated by the user, the display control unit 125 causes a first virtual object corresponding to the first real object to be displayed at a first position in the real space corresponding to the position of the first real object based on the selection made by the user. In a case in which the second real object is selected as the object to be operated by the user, the display control unit 125 causes a second virtual object corresponding to the second real object to be displayed at a second position in the real space corresponding to the position of the second real object based on the selection made by the user.

With this configuration, the virtual object corresponding to the real object selected as the object to be operated by the user is displayed, so that the virtual object more desirable for the user is displayed.

Additionally, based on the fact that the real object recognition unit 122 recognizes the real object as the candidate for the object to be operated, the display control unit 125 may cause the virtual object corresponding to the real object to be displayed at a position in the real space corresponding to the real object that is recognized as the candidate for the object to be operated. That is, the display control unit 125 may cause the first virtual object and the second virtual object to be displayed based on the fact that the first real object and the second real object are recognized as the candidates for the object to be operated. With this configuration, the user can easily grasp the real object that is recognized as the candidate for the object to be operated.

Additionally, the display control unit 125 may lower visibility of the virtual object corresponding to the real object that is not the object to be operated (real object other than the real object selected as the object to be operated) based on the selection made by the user that is determined by the determination unit 124. That is, in a case in which the first real object is selected as the object to be operated by the user, the display control unit 125 may lower the visibility of the second virtual object based on the selection made by the user. Similarly, in a case in which the second real object is selected as the object to be operated by the user, the display control unit 125 may lower the visibility of the first virtual object based on the selection made by the user. With this configuration, the user is enabled to easily grasp the selected object to be operated, and the field of vision of the user or the operation input performed by the user can be prevented from being obstructed by the virtual object corresponding to the real object other than the object to be operated.

For example, the display control unit 125 may lower the visibility of the virtual object corresponding to the real object that is not the object to be operated by controlling display not to display the virtual object corresponding to the real object that is not the object to be operated. That is, in a case in which the first real object is selected as the object to be operated by the user, the display control unit 125 may control display not to display the second virtual object based on the selection made by the user. Similarly, in a case in which the second real object is selected as the object to be operated by the user, the display control unit 125 may control display not to display the first virtual object based on the selection made by the user. With this configuration, the user is enabled to more easily grasp the selected object to be operated, and the field of vision of the user or the operation input performed by the user can be further prevented from being obstructed by the virtual object corresponding to the real object other than the object to be operated.

The method of lowering the visibility of the virtual object corresponding to the real object other than the object to be operated performed by the display control unit 125 is not limited to the method described above. For example, the display control unit 125 may lower the visibility by lowering luminance of the virtual object corresponding to the real object that is not the object to be operated, lowering saturation thereof, increasing transmittance thereof, or blurring a design thereof.

The virtual object that is caused to be displayed by the display control unit 125 may be a virtual object indicating information about the operation input using each real object. That is, the first virtual object and the second virtual object may be virtual objects indicating information about the operation input using the first real object and information about the operation input using the second real object, respectively. With this configuration, the user is enabled to grasp the information about the operation input, and perform the operation input using the object to be operated more easily.

Before the real object is selected as the object to be operated, for example, from the time point at which the real object is recognized as the candidate for the object to be operated, the display control unit 125 may cause the virtual object indicating the information about the operation input to be displayed as the virtual object corresponding to the real object. With this configuration, it becomes possible to determine which of the real objects is selected as the object to be operated based on the information about the operation input indicated by the virtual object. For example, in a case in which the virtual object including an arrow (described later) is displayed, the user can grasp information about how should the user move the real object in a case in which each real object is selected as the object to be operated, and can make a selection related to the object to be operated.

Alternatively, in a case in which the real object is selected as the object to be operated, the display control unit 125 may cause the virtual object indicating more detailed information about the operation input to be displayed as the virtual object corresponding to the real object. For example, at the time point when the real object is recognized as the candidate for the object to be operated, the display control unit 125 may cause a virtual object indicating simple information (for example, a shining effect described later) to be displayed as the virtual object corresponding to the real object. In a case in which the real object is selected as the object to be operated, the display control unit 125 may cause the virtual object indicating more detailed information (for example, the arrow described later) to be displayed as the virtual object corresponding to the real object. The virtual object indicating more detailed information may be displayed in addition to the virtual object indicating simple information. With this configuration, in a case in which there are many candidates for the object to be operated, for example, it is possible to prevent the selection of the object to be operated made by the user from being obstructed by displaying a large number of complicated virtual objects.

For example, the virtual object that is caused to be displayed by the display control unit 125 may include a virtual object indicating that the operation input receiving unit 126 (described later) can receive the operation input using the real object corresponding to the virtual object. That is, the first virtual object and the second virtual object may include a virtual object indicating that the operation input receiving unit 126 can receive the operation input using the first real object and a virtual object indicating that the operation input receiving unit 126 can receive the operation input using the second real object. The virtual object is not limited, for example, may be a shining effect, a character string indicating that the operation input can be received, or an optional virtual object displayed to be superimposed on the real object or displayed in the vicinity thereof.

With this configuration, the user is enabled to easily grasp the object to be operated that can receive the operation input, or the candidate for the object to be operated.

The virtual object that is caused to be displayed by the display control unit 125 may include a virtual object indicating an operation direction that can be received by the operation input receiving unit 126 in the operation input using the real object corresponding to the virtual object. That is, the first virtual object and the second virtual object may include a virtual object indicating the operation direction that can be received by the operation input receiving unit 126 in the operation input using the first real object and a virtual object indicating the operation direction that can be received by the operation input receiving unit 126 in the operation input using the second real object, respectively. The virtual object is not limited, and may be an arrow, for example.

With this configuration, the user is enabled to grasp a direction in which the object to be operated should be moved to perform the operation input.

The virtual object that is caused to be displayed by the display control unit 125 may include a virtual object indicating an operation range that can be received by the operation input receiving unit 126 in the operation input using the real object corresponding to the virtual object. That is, the first virtual object and second virtual object include a virtual object indicating the operation range that can be received by the operation input receiving unit 126 in the operation input using the first real object and a virtual object indicating the operation range that can be received by the operation input receiving unit 126 in the operation input using the second real object, respectively. The virtual object is not limited, and may be a frame or a line segment, for example.

With this configuration, the user is enabled to grasp a range in which the operation input using the object to be operated should be performed.

In a case in which the classification of the operation input using the real object is to move or rotate the real object, for example, the virtual object that is caused to be displayed by the display control unit 125 may include a virtual object indicating a scale in the operation input using the real object corresponding to the virtual object. That is, the first virtual object and the second virtual object may include a virtual object indicating a scale for the operation input using the first real object and a virtual object indicating a scale for the operation input using the second real object, respectively. The virtual object is not limited, and may be divisions, an illustration, or a character string, for example. In the present description, the scale is used as an expression including a nominal scale used for distinction, an ordinal scale representing a large/small relation, an interval scale representing a difference between numerical values, or a proportional scale representing a difference and a ratio between numerical values.

With this configuration, in a case of performing the operation input for moving or rotating the object to be operated, the user is enabled to perform more appropriate operation input by referring to the virtual object indicating the scale.

The virtual object that is caused to be displayed by the display control unit 125 may include a virtual object indicating operation classification that can be received by the operation input receiving unit 126 in the operation input using the real object corresponding to the virtual object to be displayed. That is, the first virtual object and the second virtual object may include a virtual object indicating the operation classification that can be received by the operation input receiving unit 126 in the operation input using the first real object and a virtual object indicating the operation classification that can be received by the operation input receiving unit 126 in the operation input using the second real object, respectively. The virtual object is not limited, and may be a character string, for example. For example, in a case in which the operation classification that can be received by the operation input receiving unit 126 is to rotate the real object, the display control unit 125 may cause a character string of “rotate” to be displayed as the virtual object corresponding to the real object.

The virtual object that is caused to be displayed by the display control unit 125 may include a virtual object indicating a function corresponding to the operation input using the real object corresponding to the virtual object to be displayed. That is, the first virtual object and the second virtual object may include a virtual object indicating a function corresponding to the operation input using the first real object and a virtual object indicating a function corresponding to the operation input using the second real object, respectively. The virtual object is not limited, and may be a character string, for example. For example, in a case in which the function corresponding to the operation input using the real object is to change output sound volume of the speaker 14, the display control unit 125 may cause a character string of “change sound volume” to be displayed as the virtual object corresponding to the real object.

The display control unit 125 may specify the virtual object corresponding to each real object to be displayed based on the information about the real object recognized by the real object recognition unit 122. For example, the display control unit 125 may specify the virtual object corresponding to the real object to be displayed based on at least one of a shape (a square, a long and narrow shape, a cylindrical shape, and the like), a size, a design, and classification of the real object. That is, the display control unit 125 may cause the first virtual object to be displayed based on at least one of the shape, the size, and the classification of the first real object, and may cause the second virtual object to be displayed based on at least one of the shape, the size, and the classification of the second real object.

The display control unit 125 may also cause the virtual object corresponding to the real object to be displayed by specifying the operation classification, the operation direction, the operation range, the scale, the function, and the like described above in the operation input using the real object based on the shape, the size, the design, and the classification of the real object.

The operation input receiving unit 126 receives the operation input performed by the user by using the real object selected as the object to be operated. For example, the operation input receiving unit 126 may receive the operation input based on the position of the real object (object to be operated) recognized by the real object recognition unit 122 or the position of the user's hand detected by the hand detection unit 123. The operation input receiving unit 126 outputs information about the received operation input to the appliance control unit 127. The information about the operation input may include, for example, information such as an operation amount related to the operation input (a movement amount, a rotation amount, and the like) or the number of times of operation.

The appliance control unit 127 controls an appliance based on the information about the operation input received by the operation input receiving unit 126. The appliance control unit 127 may perform control related to the information processing device 1 such as luminance of the display unit 13 and sound volume of the speaker 14, or may perform control related to an external appliance (for example, an external display or speaker). In a case in which the appliance control unit 127 controls an external appliance, the appliance control unit 127 may generate a control signal for controlling the external appliance, and the communication unit 15 may transmit the control signal to the external appliance.

Display Unit 13

For example, the display unit 13 is implemented by a lens unit that performs display using a hologram optical technique (an example of a transmissive-type display unit), a liquid crystal display (LCD) device, an Organic Light Emitting Diode (OLED) device, and the like. The display unit 13 may be a transmissive type, a transflective type, or a non-transmissive type.

Speaker 14

The speaker 14 reproduces a voice signal in accordance with control performed by the control unit 12.

Communication Unit 15

The communication unit 15 is a communication module for transmitting/receiving data to/from another device in a wired or wireless manner. The communication unit 15 performs wireless communication with an external apparatus directly or via a network access point using a scheme such as a wired Local Area Network (LAN), a wireless LAN, Wireless Fidelity (Wi-Fi) (registered trademark), infrared communication, Bluetooth (registered trademark), and short-range/non-contact communication, for example.

Operation Input Unit 16

The operation input unit 16 is implemented by an operation member having a physical structure such as a switch, a button, or a lever.

Storage Unit 17

The storage unit 17 stores computer programs and parameters for executing the respective functions by the control unit 12 described above. For example, the storage unit 17 stores information about the virtual object, information about the operation input that can be received by the operation input receiving unit 126, information about an appliance that can be controlled by the appliance control unit 127, and the like.

The configuration of the information processing device 1 according to the embodiment has been specifically described above, but the configuration of the information processing device 1 according to the embodiment is not limited to the example illustrated in FIG. 2. For example, at least part of the functions of the control unit 12 of the information processing device 1 may be included in another device that is connected thereto via the communication unit 15.

### 3. OPERATION

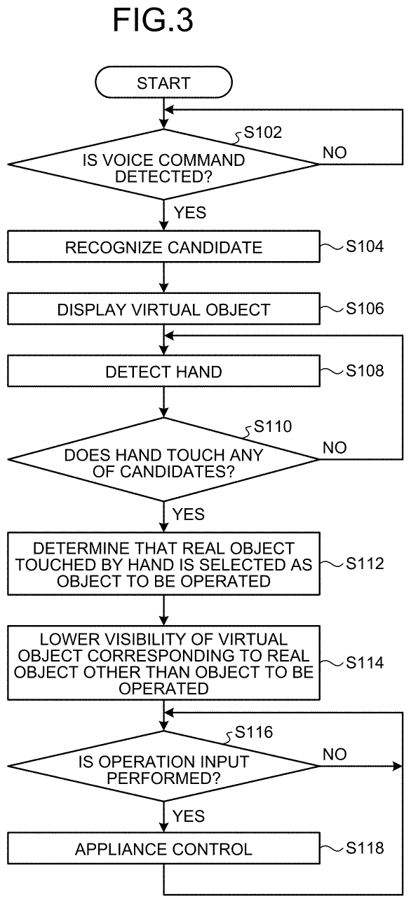

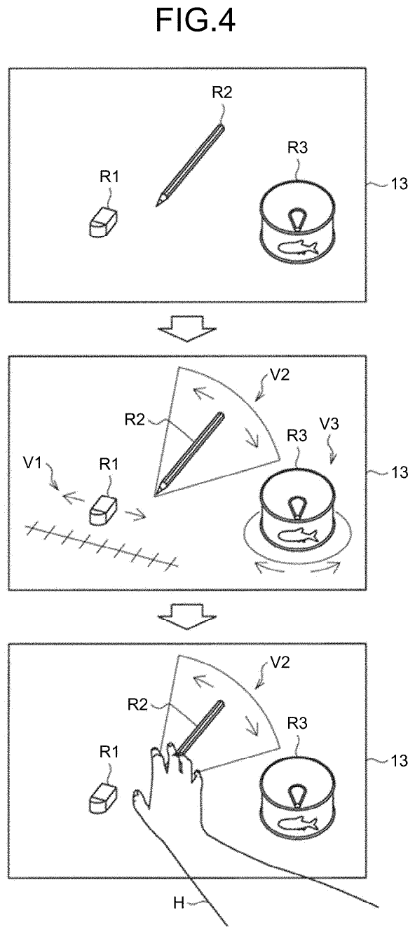

The configuration example of the information processing device 1 according to the embodiment has been described above. Subsequently, the following describes an operation of the information processing device 1 according to the embodiment with reference to FIG. 3 and FIG. 4. The following describes a processing procedure performed by the information processing device 1 with reference to FIG. 3, and describes an example of a specific operation of the information processing device 1 with reference to FIG. 4 thereafter.

### 3-1. Processing Procedure

FIG. 3 is a flowchart illustrating the processing procedure performed by the information processing device 1 according to the embodiment. First, the voice recognition unit 121 repeatedly perform processing of detecting a voice command until the voice command is detected (S102). If the voice command is detected by the voice recognition unit 121 (Yes at S102), the real object recognition unit 122 recognizes the real object present in the real space as the candidate for the object to be operated (S104). Subsequently, the display control unit 125 causes the display unit 13 to display the virtual object corresponding to the real object that is recognized as the candidate for the object to be operated at Step S104 (S106).

Subsequently, the hand detection unit 123 detects the user's hand (S108), and the determination unit 124 repeatedly performs processing of determining whether the user's hand touches any of the candidates for the object to be operated until the user's hand touches any of the candidates for the object to be operated (S110). If the determination unit 124 determines that the user's hand touches any of the candidates for the object to be operated (Yes at S110), the determination unit 124 determines that the real object touched by the user's hand is selected as the object to be operated (S112). Subsequently, based on the selection made by the user, the display control unit 125 causes the virtual object corresponding to the real object selected as the object to be operated to be displayed while lowering the visibility of the virtual object corresponding to the real object other than the object to be operated (S114).

Subsequently, the operation input receiving unit 126 repeatedly performs processing of receiving the operation input using the object to be operated (S116), and the appliance control unit 127 performs appliance control based on the received operation input (S118). As illustrated in FIG. 3, the processing at Step S116 and Step S118 may be repeated. The processing at Steps S102 to S118 described above may be successively repeated.

### 3-2. Specific Example

Subsequently, the following describes an example of a specific operation of the information processing device 1 with reference to FIG. 4. FIG. 4 is an explanatory diagram for explaining an example of the specific operation of the information processing device 1. In FIG. 4, the user wears the information processing device 1 that is a spectacle-type HMD as illustrated in FIG. 1. The display units 13 of the information processing device 1 positioned in front of the eyes of the user are transmissive type, and virtual objects V1 to V3 displayed on the display units 13 are visually recognized by the user as if being present in the real space.

First, as illustrated in an upper diagram of FIG. 4, real objects R1 to R3 are included in the field of vision of the user. In this case, when the user utters a predetermined voice command, the real object recognition unit 122 recognizes the real objects R1 to R3 as the candidates for the object to be operated, and the display control unit 125 causes the display unit 13 to display the virtual objects V1 to V3 respectively corresponding to the real objects R1 to R3 (a middle diagram of FIG. 4).

As illustrated in the middle diagram of FIG. 4, the virtual object V1 includes an arrow indicating an operation direction related to movement of the real object R3, a line segment indicating an operation range, and divisions indicating an interval scale. The virtual object V2 includes an arrow indicating an operation direction related to movement of the real object R3, and a frame indicating an operation range. The virtual object V3 includes an arrow indicating an operation direction related to rotation of the real object R3.

As illustrated in a lower diagram of FIG. 4, when a hand H of the user touches the real object R2, the display control unit 125 controls display so that the virtual object V1 corresponding to the real object R2 is displayed while the virtual object V1 and the virtual object V3 respectively corresponding to the real object R1 and the real object R3 other than the real object R2 are not displayed based on the selection made by the user.

The operation example of the information processing device 1 illustrated in FIG. 4 is merely an example, and the embodiment is not limited thereto. For example, the number of real objects recognized as the candidates for the object to be operated may be smaller than 3 or equal to or larger than 4, and the shape of the virtual object to be displayed may be various, not limited to the example in FIG. 4.

### 4. MODIFICATION

The embodiment of the present disclosure has been described above. The following describes some modifications of the embodiment. The modifications described below may be singly applied to the embodiment, or may be combined with each other to be applied to the embodiment. Each of the modifications may be applied in place of the configuration described in the embodiment, or may be additionally applied to the configuration described in the embodiment.

### 4-1. First Modification

In the embodiment described above, described is an example in which the display control unit 125 lowers the visibility of the virtual object corresponding to the real object that is not the object to be operated, but the present technique is not limited thereto. The display control unit 125 may improve the visibility of the virtual object corresponding to the object to be operated in place of or in addition to lowering the visibility of the virtual object corresponding to the real object that is not the object to be operated. That is, in a case in which the first real object is selected as the object to be operated by the user, the display control unit 125 may improve the visibility of the first virtual object based on the selection made by the user. Similarly, in a case in which the second real object is selected as the object to be operated by the user, the display control unit 125 may improve the visibility of the second virtual object based on the selection made by the user. With this configuration, the user is enabled to grasp the selected object to be operated more easily.

### 4-2. Second Modification

In the embodiment described above, mainly described is an example in which the information processing device 1 is the HMD and includes the display unit 13 of a transmissive type, but the present technique is not limited thereto. For example, even in a case in which the display unit 13 is a non-transmissive type, the same functions and effects as those described above can be implemented when the display control unit 125 causes the virtual object to be displayed being superimposed on an image in the real space obtained by imaging performed by the outward camera 110.

The information processing device 1 is not necessarily the HMD, and the display unit 13 may be a projector. In such a case, the same functions and effects as those described above can be implemented when the display control unit 125 causes the virtual object to be projected and displayed in the real space by controlling the display unit 13 serving as a projector.

### 4-3. Third Modification

In the embodiment described above, described is an example in which the predetermined voice command is used as the trigger for starting the operation input, but the present technique is not limited thereto. For example, an operation input performed by the user via the operation input unit 16, or a gesture operation input that is detected based on a taken image acquired by the outward camera 110 may be used as the trigger for starting the operation input.

### 5. HARDWARE CONFIGURATION

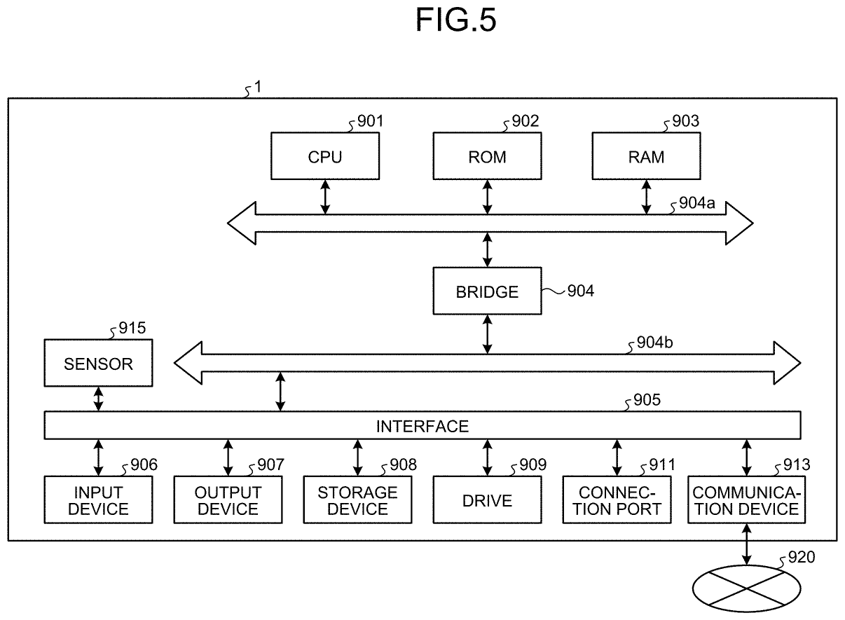

The embodiment of the present disclosure has been described above. Finally, the following describes a hardware configuration of the information processing device 1 according to the embodiment with reference to FIG. 5. FIG. 5 is a block diagram illustrating an example of the hardware configuration of the information processing device 1 according to the embodiment. Information processing performed by the information processing device 1 according to the embodiment is implemented by software and hardware (described below) cooperating with each other.

As illustrated in FIG. 5, the information processing device 1 includes a Central Processing Unit (CPU) 901, a Read Only Memory (ROM) 902, a Random Access Memory (RAM) 903, and a host bus 904a. The information processing device 1 further includes a bridge 904, an external bus 904b, an interface 905, an input device 906, an output device 907, a storage device 908, a drive 909, a connection port 911, a communication device 913, and a sensor 915. The information processing device 1 may also include a processing circuit such as a DSP or an ASIC in place of or in addition to the CPU 901.

The CPU 901 functions as an arithmetic processing device and a control device, and controls the entire operation in the information processing device 1 in accordance with various computer programs. The CPU 901 may also be a microprocessor. The ROM 902 stores computer programs, arithmetic parameters, and the like used by the CPU 901. The RAM 903 temporarily stores computer programs used for executing the CPU 901, parameters that are appropriately changed due to the execution of the CPU 901, and the like. The CPU 901 may form, for example, the control unit 12.

The CPU 901, the ROM 902, and the RAM 903 are connected to each other via the host bus 904a including a CPU bus and the like. The host bus 904a is connected to the external bus 904b such as a Peripheral Component Interconnect/Interface (PCI) bus via the bridge 904. The host bus 904a, the bridge 904, and the external bus 904b are not necessarily configured in a separated manner, and these functions may be implemented as one bus.

The input device 906 is, for example, implemented by a device to which information is input by the user such as a mouse, a keyboard, a touch panel, a button, a microphone, a switch, and a lever. For example, the input device 906 may also be a remote control device utilizing infrared rays or other radio waves, or an external connection appliance such as a cellular telephone or a PDA supporting an operation of the information processing device 1. The input device 906 may further include, for example, an input control circuit that generates an input signal based on information that is input by the user using the input unit described above, and outputs the input signal to the CPU 901. The user of the information processing device 1 can input various kinds of data or give an instruction to perform processing operation to the information processing device 1 by operating the input device 906.

The output device 907 is formed of a device that can visually or aurally notify the user of acquired information. As such a device, exemplified are a display device such as a CRT display device, a liquid crystal display device, a plasma display device, an EL display device, and a lamp, a voice output device such as a speaker and a headphone, a printer device, and the like. For example, the output device 907 outputs a result obtained through various kinds of processing performed by the information processing device 1. Specifically, the display device visually displays the result obtained through various kinds of processing performed by the information processing device 1 in various formats such as text, an image, a table, and a graph. On the other hand, the voice output device converts an audio signal constituted of reproduced voice data, audio data, and the like into an analog signal to be aurally output. The output device 907 may form the display unit 13 and the speaker 14, for example.

The storage device 908 is a device for storing data that is formed as an example of a storage unit of the information processing device 1. The storage device 908 is implemented by, for example, a magnetic storage unit device such as an HDD, a semiconductor storage device, an optical storage device, or a magneto-optical storage device. The storage device 908 may include a storage medium, a recording device that records data in the storage medium, a reading device that reads out data from the storage medium, a deletion device that deletes data recorded in the storage medium, and the like. The storage device 908 stores a computer program executed by the CPU 901, various kinds of data, various kinds of data acquired from the outside, and the like. The storage device 908 described above may form the storage unit 17, for example.

The drive 909 is a reader/writer for a storage medium, and is incorporated in the information processing device 1, or externally attached thereto. The drive 909 reads out information recorded in a removable storage medium mounted thereon such as a magnetic disc, an optical disc, a magneto-optical disc, or a semiconductor memory, and outputs the information to the RAM 903. The drive 909 can also write the information into the removable storage medium.

The connection port 911 is an interface that is connected to an external apparatus, for example, a connection port for an external apparatus to which data can be transmitted via a Universal Serial Bus (USB) and the like.

The communication device 913 is, for example, a communication interface formed of a communication device and the like to be connected to the network 920. The communication device 913 is, for example, a communication card for a wired or wireless Local Area Network (LAN), Long Term Evolution (LTE), Bluetooth (registered trademark), or a Wireless USB (WUSB). The communication device 913 may also be a router for optical communication, a router for an Asymmetric Digital Subscriber Line (ADSL), a modem for various kinds of communication, or the like. The communication device 913 can transmit/receive a signal and the like to/from the Internet or another communication device according to a predetermined protocol such as TCP/IP, for example. The communication device 913 may form the communication unit 15, for example.

The sensor 915 is, for example, various sensors such as an acceleration sensor, a gyro sensor, a geomagnetic sensor, an optical sensor, a sound sensor, a range sensor, and a force sensor. The sensor 915 acquires information about a state of the information processing device 1 itself such as a posture and a moving speed of the information processing device 1, and information about a peripheral environment of the information processing device 1 such as brightness and noise around the information processing device 1. The sensor 915 may also include a GPS sensor that receives GPS signals to measure latitude, longitude, and altitude of a device. The sensor 915 may form, for example, the sensor unit 11.

The network 920 is a wired or wireless transmission path for information transmitted from a device connected to the network 920. For example, the network 920 may include a public network such as the Internet, a telephone line network, and a satellite communication network, various kinds of Local Area Network (LAN) including Ethernet (registered trademark), a Wide Area Network (WAN), and the like. The network 920 may also include a dedicated network such as an Internet Protocol-Virtual Private Network (IP-VPN).

The example of the hardware configuration that can implement the function of the information processing device 1 according to the embodiment has been described above. The constituent elements described above may be implemented by using a versatile member, or may be implemented as hardware dedicated to the function of each constituent element. Thus, a hardware configuration to be utilized can be appropriately changed depending on a technical level at each time of implementing the embodiment.

A computer program can be made for implementing each function of the information processing device 1 according to the embodiment as described above, and the computer program may be implemented on a PC and the like. A computer-readable recording medium storing such a computer program can also be provided. The recording medium is, for example, a magnetic disc, an optical disc, a magneto-optical disc, and a flash memory. The computer program described above may be distributed via a network, for example, without using a recording medium.

### 6. CONCLUSION

As described above, according to the embodiment of the present disclosure, assignment of the object to be operated more preferred by the user and display of the virtual object desired by the user are implemented by assigning the object to be operated and displaying the virtual object based on the selection made by the user. According to the embodiment, by displaying the virtual object corresponding to each of the real objects recognized as the candidates for the object to be operated, the user is enabled to easily grasp the real object recognized as the candidate for the object to be operated. Additionally, according to the embodiment, by lowering the visibility of the virtual object corresponding to the real object other than the object to be operated selected by the user, the field of vision of the user and the operation input performed by the user can be prevented from being obstructed.

The preferred embodiment of the present disclosure has been described above in detail with reference to the attached drawings, but the technical scope of the present disclosure is not limited to the example herein. A person ordinarily skilled in the art of the present disclosure can obviously conceive various examples of variations or modifications within a scope of technical idea described in CLAIMS, and it is obvious that these examples are also encompassed by the technical scope of the present disclosure.

For example, the steps in the embodiment described above are not necessarily processed on a time-series basis in accordance with the order described herein as the flowchart. For example, the steps in the processing of the embodiment described above may be processed in order different from the order described as the flowchart, or may be processed in parallel.

The effects described in the present description are merely explanation or examples, and are not limitations. That is, the technique according to the present disclosure can exhibit another effect that is obvious to those skilled in the art from the description herein in addition to the effect described above, or in place of the effect described above.

The following configurations are also encompassed by the technical scope of the present disclosure.

(1)

An information processing device comprising:

a display control unit configured to control display so that, of a first real object and a second real object that are present in a real space and recognized as candidates for an object to be operated, in a case in which the first real object is selected by a user as the object to be operated, a first virtual object corresponding to the first real object is caused to be displayed at a first position in the real space corresponding to a position of the first real object based on the selection made by the user, and in a case in which the second real object is selected by the user as the object to be operated, a second virtual object corresponding to the second real object is caused to be displayed at a second position in the real space corresponding to a position of the second real object based on the selection made by the user.

(2)

The information processing device according to (1), wherein the display control unit causes the first virtual object and the second virtual object to be displayed based on the fact that the first real object and the second real object are recognized as the candidates for the object to be operated.

(3)

The information processing device according to (2), wherein, in a case in which the first real object is selected by the user as the object to be operated, the display control unit lowers visibility of the second virtual object based on the selection made by the user, and in a case in which the second real object is selected by the user as the object to be operated, the display control unit lowers visibility of the first virtual object based on the selection made by the user.

(4)

The information processing device according to (2), wherein, in a case in which the first real object is selected by the user as the object to be operated, the display control unit controls display so that the second virtual object is not displayed based on the selection made by the user, and in a case in which the second real object is selected by the user as the object to be operated, the display control unit controls display so that the first virtual object is not displayed based on the selection made by the user.

(5)

The information processing device according to any one of (2) to (4), wherein, in a case in which the first real object is selected by the user as the object to be operated, the display control unit improves visibility of the first virtual object based on the selection made by the user, and in a case in which the second real object is selected by the user as the object to be operated, the display control unit improves visibility of the second virtual object based on the selection made by the user.

(6)

The information processing device according to (1), wherein the display control unit causes the first virtual object to be displayed based on at least one of a shape, a size, a design, and classification of the first real object, and causes the second virtual object to be displayed based on at least one of a shape, a size, and classification of the second real object.

(7)

The information processing device according to any one of (1) to (6), further comprising:

an operation input receiving unit configured to receive an operation input using the real object selected by the user as the object to be operated.

(8)

The information processing device according to (7), wherein the first virtual object and the second virtual object indicate information about the operation input using the first real object and information about the operation input using the second real object, respectively.

(9)

The information processing device according to (8), wherein the first virtual object and the second virtual object that are caused to be displayed by the display control unit include a virtual object indicating that the operation input using the first real object is able to be received by the operation input receiving unit and a virtual object indicating that the operation input using the second real object is able to be received by the operation input, respectively.

(10)

The information processing device according to (8) or (9), wherein the first virtual object and the second virtual object include a virtual object indicating an operation direction that is able to be received by the operation input receiving unit in the operation input using the first real object and a virtual object indicating an operation direction that is able to be received by the operation input receiving unit in the operation input using the second real object, respectively.

(11)

The information processing device according to any one of (8) to (10), wherein the first virtual object and the second virtual object include a virtual object indicating an operation range that is able to be received by the operation input receiving unit in the operation input using the first real object and a virtual object indicating an operation range that is able to be received by the operation input receiving unit in the operation input using the second real object, respectively.

(12)

The information processing device according to any one of (8) to (11), wherein the first virtual object and the second virtual object include a virtual object indicating a scale for the operation input using the first real object and a virtual object indicating a scale for the operation input using the second real object, respectively.

(13)

The information processing device according to any one of (8) to (12), wherein the first virtual object and the second virtual object that are caused to be displayed by the display control unit include a virtual object indicating operation classification that is able to be received by the operation input receiving unit in the operation input using the first real object and a virtual object indicating operation classification that is able to be received by the operation input receiving unit in the operation input using the second real object, respectively.

(14)

The information processing device according to any one of (8) to (13), wherein the first virtual object and the second virtual object that are caused to be displayed by the display control unit include a virtual object indicating a function corresponding to the operation input using the first real object and a virtual object indicating a function corresponding to the operation input using the second real object, respectively.

(15)

The information processing device according to any one of (1) to (14), further comprising:

a determination unit configured to perform determination related to a selection of the object to be operated made by the user, wherein

the determination unit determines that the first real object is selected as the object to be operated in a case in which the user touches the first real object, and determines that the second real object is selected as the object to be operated in a case in which the user touches the second real object.

(16)

The information processing device according to any one of (1) to (15), wherein the display control unit controls display performed by a display unit of a transmissive type.

(17)

An information processing method comprising:

controlling display by a processor so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.

(18)

A computer program for causing a computer to implement a function of controlling display so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.

### REFERENCE SIGNS LIST

INFORMATION PROCESSING DEVICE
11 SENSOR UNIT
12 CONTROL UNIT
13 DISPLAY UNIT
14 SPEAKER
15 COMMUNICATION UNIT
16 OPERATION INPUT UNIT
17 STORAGE UNIT
110 OUTWARD CAMERA
111 INWARD CAMERA
112 MIC
113 GYRO SENSOR
114 ACCELERATION SENSOR
115 AZIMUTH SENSOR
116 POSITION MEASURING UNIT
117 BIOSENSOR
121 VOICE RECOGNITION UNIT
122 REAL OBJECT RECOGNITION UNIT
123 HAND DETECTION UNIT
124 DETERMINATION UNIT
125 DISPLAY CONTROL UNIT
126 OPERATION INPUT RECEIVING UNIT
127 APPLIANCE CONTROL UNIT

1. An information processing device comprising:
a display control unit configured to control display so that, of a first real object and a second real object that are present in a real space and recognized as candidates for an object to be operated, in a case in which the first real object is selected by a user as the object to be operated, a first virtual object corresponding to the first real object is caused to be displayed at a first position in the real space corresponding to a position of the first real object based on the selection made by the user, and in a case in which the second real object is selected by the user as the object to be operated, a second virtual object corresponding to the second real object is caused to be displayed at a second position in the real space corresponding to a position of the second real object based on the selection made by the user.

2. The information processing device according to claim 1, wherein the display control unit causes the first virtual object and the second virtual object to be displayed based on the fact that the first real object and the second real object are recognized as the candidates for the object to be operated.

3. The information processing device according to claim 2, wherein, in a case in which the first real object is selected by the user as the object to be operated, the display control unit lowers visibility of the second virtual object based on the selection made by the user, and in a case in which the second real object is selected by the user as the object to be operated, the display control unit lowers visibility of the first virtual object based on the selection made by the user.

4. The information processing device according to claim 2, wherein, in a case in which the first real object is selected by the user as the object to be operated, the display control unit controls display so that the second virtual object is not displayed based on the selection made by the user, and in a case in which the second real object is selected by the user as the object to be operated, the display control unit controls display so that the first virtual object is not displayed based on the selection made by the user.

5. The information processing device according to claim 2, wherein, in a case in which the first real object is selected by the user as the object to be operated, the display control unit improves visibility of the first virtual object based on the selection made by the user, and in a case in which the second real object is selected by the user as the object to be operated, the display control unit improves visibility of the second virtual object based on the selection made by the user.

6. The information processing device according to claim 1, wherein the display control unit causes the first virtual object to be displayed based on at least one of a shape, a size, a design, and classification of the first real object, and causes the second virtual object to be displayed based on at least one of a shape, a size, and classification of the second real object.

7. The information processing device according to claim 1, further comprising:
an operation input receiving unit configured to receive an operation input using the real object selected by the user as the object to be operated.

8. The information processing device according to claim 7, wherein the first virtual object and the second virtual object indicate information about the operation input using the first real object and information about the operation input using the second real object, respectively.

9. The information processing device according to claim 8, wherein the first virtual object and the second virtual object that are caused to be displayed by the display control unit include a virtual object indicating that the operation input using the first real object is able to be received by the operation input receiving unit and a virtual object indicating that the operation input using the second real object is able to be received by the operation input, respectively.

10. The information processing device according to claim 8, wherein the first virtual object and the second virtual object include a virtual object indicating an operation direction that is able to be received by the operation input receiving unit in the operation input using the first real object and a virtual object indicating an operation direction that is able to be received by the operation input receiving unit in the operation input using the second real object, respectively.

11. The information processing device according to claim 8, wherein the first virtual object and the second virtual object include a virtual object indicating an operation range that is able to be received by the operation input receiving unit in the operation input using the first real object and a virtual object indicating an operation range that is able to be received by the operation input receiving unit in the operation input using the second real object, respectively.

12. The information processing device according to claim 8, wherein the first virtual object and the second virtual object include a virtual object indicating a scale for the operation input using the first real object and a virtual object indicating a scale for the operation input using the second real object, respectively.

13. The information processing device according to claim 8, wherein the first virtual object and the second virtual object that are caused to be displayed by the display control unit include a virtual object indicating operation classification that is able to be received by the operation input receiving unit in the operation input using the first real object and a virtual object indicating operation classification that is able to be received by the operation input receiving unit in the operation input using the second real object, respectively.

14. The information processing device according to claim 8, wherein the first virtual object and the second virtual object that are caused to be displayed by the display control unit include a virtual object indicating a function corresponding to the operation input using the first real object and a virtual object indicating a function corresponding to the operation input using the second real object, respectively.

15. The information processing device according to claim 1, further comprising:
a determination unit configured to perform determination related to a selection of the object to be operated made by the user, wherein
the determination unit determines that the first real object is selected as the object to be operated in a case in which the user touches the first real object, and determines that the second real object is selected as the object to be operated in a case in which the user touches the second real object.

16. The information processing device according to claim 1, wherein the display control unit controls display performed by a display unit of a transmissive type.

17. An information processing method comprising:
controlling display by a processor so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.

18. A computer program for causing a computer to implement a function of controlling display so that, of a first real object and a second real object present in a real space that are recognized as candidates for an object to be operated, in a case in which the first real object is selected by a user as the object to be operated, a first virtual object corresponding to the first real object is displayed at a first position in the real space corresponding to a position of the first real object based on the selection made by the user, and in a case in which the second real object is selected by the user as the object to be operated, a second virtual object corresponding to the second real object is displayed at a second position in the real space corresponding to a position of the second real object based on the selection made by the user.
